(19) United States
(12) Patent Application Publication
(10) Pub. No.: US 2010/0327177 A1
(43) Pub. Date: Dec. 30, 2010

(54) CASKET CARRIER DEVICE

(76) Inventor: Scott Michael Flynn, Oakwood, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/818,608

(22) Filed: Jun. 18, 2010

Related U.S. Application Data
(60) Provisional application No. 61/220,324, filed on Jun. 25, 2009.

(51) Int. Cl. A61G 17/00; A61G 99/00; G01T 1/00

(52) U.S. Cl. 250/395; 27/2; 27/27

(57) ABSTRACT

A carrier device for use in conjunction with a casket, the device having side handlebars, end handlebars and handlebar joints that are attached to form a rectangular shape; and a plurality of support structures that span between and attach to the handlebars, wherein the support structures are composed of a plurality of attachment bars and attachment tabs. The carrier device attaches to the bottom face of a casket by the attachment bars of the support structures.

### CROSS-REFERENCE TO RELATED APPLICATION

This application claims the benefit of U.S. Provisional Patent Application Ser. No. 61/220,324, filed Jun. 25, 2009, the entirety of which is hereby incorporated herein by reference for all purposes.

### TECHNICAL FIELD

The present invention relates generally to the field of funeral and burial devices, and more particularly to a device for transporting, displaying, shipping, and/or locating a funeral casket; and to a casket equipped with such a device.

### BACKGROUND

Caskets are commonly used to inter the remains of the deceased. Caskets are carried by pallbearers, who are individuals chosen to carry the casket during a religious or memorial service and to the grave site. Pallbearers typically lift and transport a casket by holding handles that are attached to the sides, head, or foot of a casket, and carrying the casket to its destination. It is to the provision of an improved casket and to improved carrying mechanisms for caskets that the present invention is primarily directed.

### SUMMARY

It has become desirable in the casket building industry to customize and decorate caskets according to the desires of the deceased or their family. The customization of a casket's sides, top, head, and/or foot may satisfy sentimental or decorative desires. However, it has been found that full and uninhibited customization of at least some portions of a casket's sides, head, and foot are often limited due to the presence of casket handles that protrude from the sides, head, and foot of a casket. The present invention provides a base or carrier for a casket that does not interfere with customization or decoration of the entire side portions of a casket.

In example embodiments, the present invention relates to a carrier device for a casket including first and second side rail portions and first and second end rail portions forming a peripheral frame, and further including at least one cross-member extending across the peripheral frame for supporting a casket thereon.

In another aspect, the invention relates to a casket having a bottom, a top, first and second side panels and first and second end panels. The casket further includes a carrier base, the carrier base having first and second side rail portions and first and second end rail portions forming a peripheral frame. The carrier base further includes at least one cross-member extending across the peripheral frame for supporting the bottom of the casket thereon

In still another aspect, the invention relates to a method of locating an underground grave site. The method includes burying a carrier base having a peripheral frame surrounding the grave site, at least a portion of the carrier base being radiopaque, radiographically surveying an area, and identifying the grave site by locating a radiographic image of the radiopaque portion of the carrier base.

In another aspect, the invention relates to a carrier base support or peripheral handlebar carrying device for lifting and transporting a funeral casket. In one aspect, the present invention relates to a carrier base for transporting a casket, the carrier base having poles or bars that surround the casket and attach to the bottom face of the casket.

In another aspect, the invention relates to a carrier for a casket, the carrier having a peripheral handlebar structure formed of first and second side handlebars and first and second end handlebars, and a plurality of cross-member carriers extending between the first and second side handlebars, for supporting a casket thereon.

In another aspect, the invention relates to a casket comprising a shell having a top, a bottom, first and second sides, and first and second ends. The first and second sides and the first and second ends are substantially unobstructed by handles, and the bottom of the casket is supported upon a carrier base including a peripheral handlebar structure and a plurality of cross-member carriers.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a perspective view from and end of a carrier base according to an example embodiment of the present invention.

FIG. 2 is a perspective view of a casket mounted on a carrier base according to an example form of the present invention.

FIG. 3 is a detailed side view of a corner portion of a carrier base and casket.

FIG. 4 is a detailed end view of a corner portion of a carrier base and casket.

FIG. 5 is an end view of a casket mounted on a carrier base according to an example form of the present invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

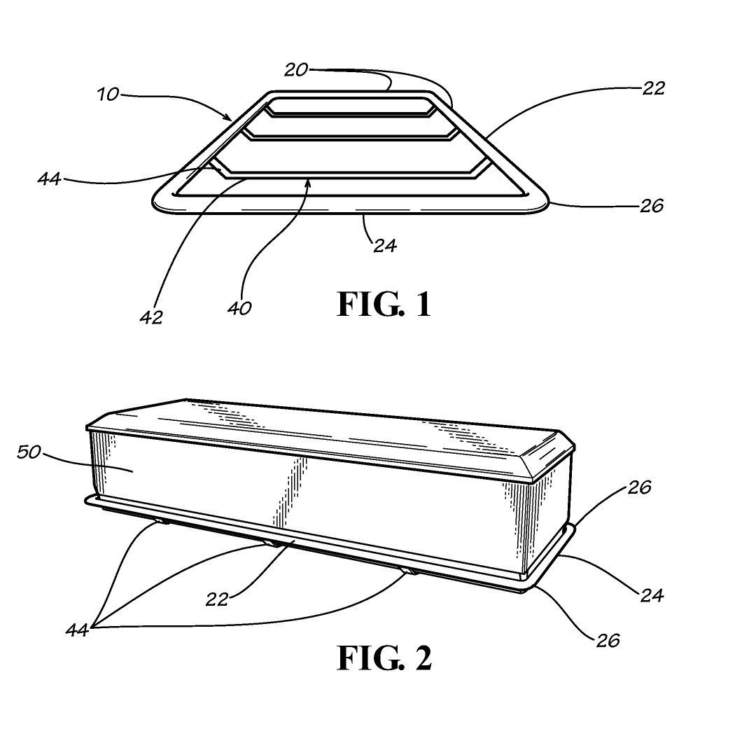

With reference now to the drawing figures, wherein like reference numbers represent corresponding parts throughout the several views, FIGS. 1-5 show example forms and applications of a carrier base or peripheral handlebar device 10 according to the present invention. The carrier 10 generally comprises one or more peripheral handlebars or rails 20 and one or more support cross-member structures 40. The handlebars 20 may be considered as comprising a pair of side handlebar portions 22, a pair of end handlebar portions 24, and four handlebar corner joints 26 at the intersections of the side and end portions. In the depicted embodiment, side handlebars 22 are equal in length but both are longer in length than end handlebars 24, which are also equal in length.

The side handlebars and end handlebars are longer than the length and width of the casket, respectively, to provide a space having a width W (see FIG. 5) for access between the casket and the handlebars for the pallbearers hands. Side handlebars 22 and end handlebars 24 are joined together by handlebar corner joints 26. The ends of the side handlebars and ends of the end handlebars are attached to the handlebar joints by welding, bolts or other attachment means suitable for the type of material of which they are composed. In alternate embodiments, a unitary and continuous oval or otherwise shaped handlebar arrangement can be provided. In example forms, the rails or bars 20 are constructed of tubular or cylindrical steel, aluminum or other metal, and have a diameter of approximately 1″.

One or more support cross-member structures 40 are spaced along the length and/or the width of the carrier, extending between the side handlebars 22 and/or between the end handlebars 24. In the depicted embodiment, there are three support cross-members 40 that are substantially equally spaced apart along the length of the carrier, and attached at either end to one of the side handlebars. In alternate embodiments, one, two, four, or more cross-members are provided. In example form, the support cross-member structures are formed by bending a flat metal bar with the same angle in two equally spaced distal locations in the same plane to form angled or curved attachment tabs 44 extending from each end of the attachment bar 42. Preferably the flat portion of the attachment bar 42 is as long as the width of the casket that will be carried thereon, so that the base of the casket rests on the flat attachment bar portion and is adjacent or slightly beneath the level of the side handlebars for stability. The angled or curved attachment tabs 44 are welded, bolted or otherwise affixed to the side handlebars, or are integrally formed therewith.

The attachment bars 42 attach to or support the bottom face of a casket and the attachment tabs 44 extend upwardly and outwardly therefrom at an angle of about 120°-150° and preferably about 135°, resulting in an angle α as shown in FIG. 5 of between 30-60° and preferably about 45°, such that the handles 20 are raised above the attachment bar by a drop or height H and spaced away from the sides of the casket by a width W, as shown in FIG. 5, providing ease of hand access for the pallbearers and allowing the handle to be grasped underneath when the unit is on a flat surface such as the floor or bed of a hearse or van. In example embodiments, the height Hand width Ware each at least about 1 ¼″ to about 2″.

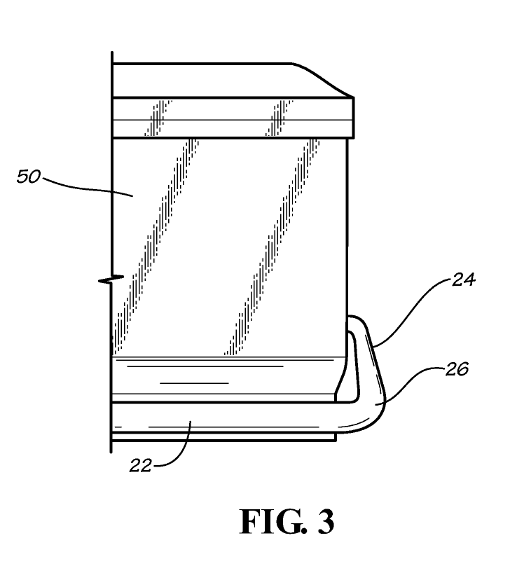

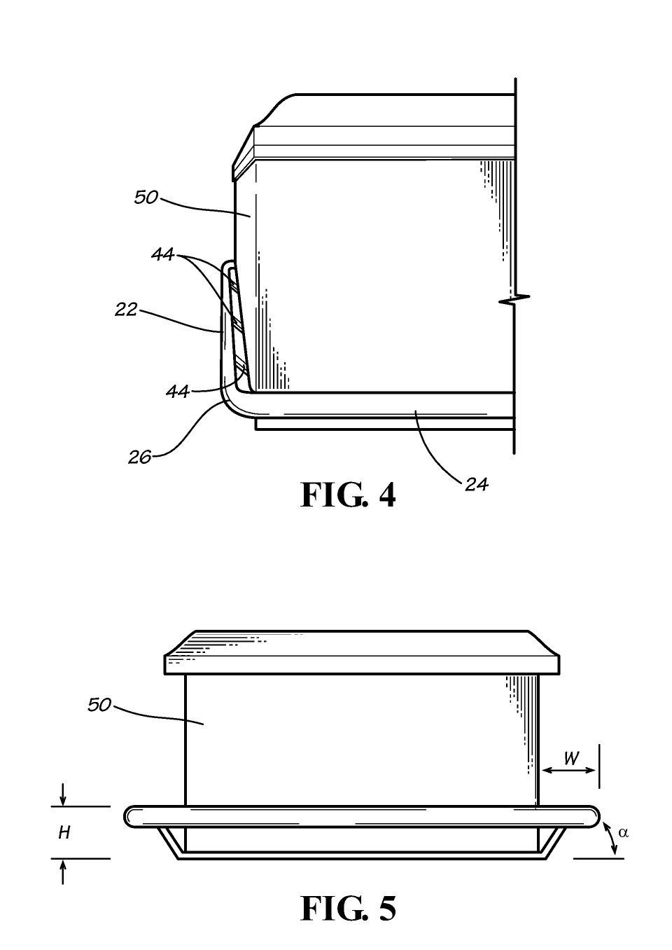

As seen in FIGS. 2-5, the carrier device 10 is used in conjunction with a casket 50. The casket is supported on top of the attachment bars 42, with the rails 20 surrounding the periphery of the casket. The sides, head, and foot of the casket preferably do not have any handles or mounting hardware affixed thereon, leaving the sides, head, and foot of the casket unobstructed for decoration or customization. As seen in FIGS. 3-5, the side handlebars 22 and the end handlebars 24 are separated a distance away from the base portion of the casket when the casket is placed on top of the attachment bars. FIG. 4 shows side handlebar 22, end handlebar 24, and the handlebar joint 26 in greater detail. Optionally, the bottom surface comprises one or more dados, slots or channels recessed therein and extending across the width of the casket to receive the cross-members 40 of the carrier base, to more securely engage the casket to the carrier base and to provide a continuous smooth and flat bottom surface of the carrier base/casket unit.

The carrier base of the present invention enables increased lifting capacity, whereas it has been found that in some instances the load of a casket may be more than traditional handle attachment means can bear. The carrier 10 preferably is constructed to carry a load of at least 1000 pounds, although can be configured for greater or lesser loading depending on the particular application. The carrier can be configured in various sizes to accommodate oversized or smaller caskets. By surrounding the entire periphery of the casket, example forms of the invention serve as a “bumper” to protect the casket from damage, and allow additional pallbearers to assist in carrying the casket from all sides and/or in loading and unloading the casket from a hearse. The carrier can be constructed of steel, aluminum or other metals, and optionally is powder-coated, painted, or otherwise treated for aesthetics and corrosion resistance. Because the carrier of the present invention supports the casket from beneath, rather than from handles affixed to the side of the casket, additional support and protection is provided to the undercarriage of the casket, and better load-bearing is provided preventing handle detachment from overloading. The casket can be permanently affixed to the carrier as by screws or other fasteners, or can be unattached and maintained in place on the carrier by its weight and friction alone.

Additionally, protocol for respectfully carrying a casket specifies that a casket should be carried above the waistline of the pallbearers. Because the carrier base of the present invention supports the bottom face of the casket from underneath, with the casket positioned above the carrying supports, the carrier base better allows proper positioning of the casket while the pallbearers' arms are straight, providing additional ease in lifting and carrying the casket. The carrier base of the present invention also allows more pallbearers to carry a casket than traditional side-mounted handle configurations.

By providing a protective metal frame surrounding the entire perimeter of a casket, the carrier base also enables improved methods of shipping, storing and displaying caskets, and for preventing damage to the casket, according to other aspects of the present invention. This enables a casket incorporating the carrier base to be transported, stored and/or displayed for viewing or for product marketing in angled or upright (head-to-toe or side-to-side) orientations. The metal of the carrier base also keeps wood parts of a casket out of contact with the ground and allows air circulation around the casket, reducing the incidence of dry rot or water damage. Also, the side extensions provided by the carrier base can serve as a support rail allowing a casket to slide along a channel or bracket support in a vehicle, storage site or mausoleum, and be placed and removed in a similar fashion to opening and closing a drawer.

During interment, the side handles of the carrier base provide contact points for the lowering straps as the casket is lowered into a vault or into the ground, easing tension on the straps and reducing wear, thereby reducing the incidence of straps breaking, and also preventing damage to the sides of the casket by the straps. The straps flex about the round profile of the carrier base at about a 45° angle and thus avoid the sharp bends and corners encountered in typical interment methods. The carrier base also provides an attachment point for a lifting hook for raising a casket, thereby enabling an improved method of disinterment.

In “green” burials utilizing biodegradable caskets or shrouds, the carrier base provides additional support during transport and interment. Also, the carrier base provides a radiopaque peripheral marker for unmarked graves not having a headstone or other type of marker, allowing ground-penetrating radar or x-ray location of a grave site. Optionally, one or more unique radiopaque identifiers or patterns are provided on the carrier base for distinguishing a particular grave from other graves.

While the invention has been described with reference to preferred and example embodiments, it will be understood by those skilled in the art that a variety of modifications, additions and deletions are within the scope of the invention, as defined by the following claims.

What is claimed is:

1. A carrier device for a casket comprising first and second side rail portions and first and second end rail portions forming a peripheral frame, and further comprising at least one cross-member extending across the peripheral frame for supporting a casket thereon.

2. The carrier device of claim 1, wherein the first and second side rail portions and first and second end rail portions are connected at their ends by radiused corner portions.

3. The carrier device of claim 1, wherein the first and second side rail portions and first and second end rail portions are connected at right angles, and the peripheral frame is generally rectangular.

4. The carrier device of claim 1, wherein the first and second side rail portions are longer than the first and second end rail portions, and wherein the at least one cross-member extends between the first and second side rail portions.

5. The carrier device of claim 1, comprising a plurality of cross-members.

6. The carrier device of claim 1, further comprising angled attachment tabs connecting each end of the at least one cross-member to the peripheral frame.

7. The carrier device of claim 6, wherein the angled attachment tabs position the first and second side rail portions and first and second end rail portions at least about 1 ¼″ from the sides of the casket.

8. The carrier device of claim 6, wherein the angled attachment tabs position the first and second side rail portions and first and second end rail portions at least about 1 ¼″ above the base of the at least one cross-member.

9. The carrier device of claim 1, wherein the first and second side rail portions and first and second end rail portions comprise a radiopaque material.

10. The carrier device of claim 1, wherein the carrier device can support a load of at least 1000 pounds.

11. The carrier device of claim 1, wherein no portion of the peripheral frame contacts the sides or ends of the casket during use.

12. A casket comprising a bottom, a top, first and second side panels and first and second end panels, and further comprising a carrier base, the carrier base comprising first and second side rail portions and first and second end rail portions forming a peripheral frame, the carrier base further comprising at least one cross-member extending across the peripheral frame for supporting the bottom of the casket thereon.

13. The casket of claim 12, wherein the first and second side rail portions and first and second end rail portions are connected at their ends by radiused corner portions.

14. The casket of claim 12, wherein the first and second side rail portions and first and second end rail portions are connected at right angles, and the peripheral frame is generally rectangular.

15. The casket of claim 12, wherein the first and second side rail portions are longer than the first and second end rail portions, and wherein the at least one cross-member extends between the first and second side rail portions.

16. The casket of claim 12, comprising a plurality of cross-members.

17. The casket of claim 12, further comprising angled attachment tabs connecting each end of the at least one cross-member to the peripheral frame.

16. The casket of claim 17, wherein the angled attachment tabs position the first and second side rail portions at least about 1 ¼″ from the first and second side panels of the casket.

17. The casket of claim 17, wherein the angled attachment tabs position the first and second side rail portions and first and second end rail portions at least about 1 ¼″ above the base of the at least one cross-member.

18. The casket of claim 12, wherein the first and second side rail portions and first and second end rail portions comprise a radiopaque material.

19. The casket of claim 12, wherein the carrier device can support a casket load of at least 1000 pounds.

20. The casket of claim 12, wherein no portion of the peripheral frame contacts the side panels or end panels of the casket during use.

21. A method of locating an underground grave site, comprising burying a carrier base having a peripheral frame surrounding the grave site, at least a portion of the carrier base being radiopaque, radiographically surveying an area, and identifying the grave site by locating a radiographic image of the radiopaque portion of the carrier base.

22. The method of claim 21, wherein the grave site is unmarked.

23. The method of claim 21, wherein the radiopaque portion of the carrier base comprises a distinguishing identifier.
